(19) United States
(12) Patent Application Publication
(10) Pub. No.: US 2017/0103557 A1
(43) Pub. Date: Apr. 13, 2017

(54) LOCALIZED BRUSH STROKE PREVIEW

(71) Applicant: Adobe Systems Incorporated, San Jose, CA (US)

(72) Inventors: Nishant Kumar, Noida (IN); Mohit Gupta, Noida (IN); Kamal Arora, Delhi (IN)

(21) Appl. No.: 14/881,591

(22) Filed: Oct. 13, 2015

(51) Int. Cl. G06T 11/60; G06F 3/0481; G06F 3/0484; G06T 11/20

(52) U.S. Cl. CPC G06T 11/60; G06T 11/203; G06F 3/0481; G06F 3/04842; G06F 3/04812; G06F 3/04845; G06T 2200/24

(57) ABSTRACT

Embodiments of the present invention provide systems, methods, and computer storage media directed to a graphics editor that enables a localized preview of the effect of a selected digital brush. Such a graphics editor can be configured to determine a region of an image that is rendered on a display of the computing device that the user wishes to view a localized preview of. This region can, for example, be determined based on input received from a user of the computing device selecting the region. The graphics editor can then be configured to cause a localized preview to be rendered on a display of the computing device, where the localized preview reflects application of the selected digital brush to the determined region. Other embodiments may be described and/or claimed.

### BACKGROUND

Many image editing applications include digital brushes that can be utilized to apply brush strokes or effects to a digital image to selectively modify various regions of a digital image. For example, brush strokes may be used to apply various textures, patterns, shading, shapes, styles, gradients, and/or the like. Typically, a user wishing to utilize a digital brush to selectively modify an area of a digital image makes an initial prediction as to the digital brush that might accomplish a desired modification and then applies the digital brush to the image. Oftentimes, however, the initially selected digital brush does not accomplish the modification that was desired by the user. As such, the user must go through an iterative process (e.g., undoing, reverting, reselecting, and/or reapplying) to identify an appropriate or desired brush stroke to achieve the desired modification. This can continue through many cycles until the user finally achieves the desired modification or gives up and accepts the modification as is, which would result in a modification that was not what was desired by the user. As such, this iterative process can be very time consuming and ultimately frustrating for the user as the user struggles to achieve the desired modification.

### BRIEF DESCRIPTION OF THE DRAWINGS

FIG. 1 depicts an illustrative computing environment in which various embodiments of the present disclosure may be employed.

FIG. 2 depicts application of a digital brush and movement of a selected region, in accordance with various embodiments of the present disclosure.

FIG. 3 depicts updating of a localized preview, in accordance with various embodiments of the present disclosure.

FIG. 4 depicts generating and display of a localized preview, in accordance with various embodiments of the present disclosure.

FIG. 5 is a flow diagram showing an illustrative method for facilitating a localized preview in accordance with various embodiments of the present disclosure.

FIG. 6 is a flow diagram showing an illustrative method for determining a region of a rendered image that the user wishes to see a localized preview of in accordance with various embodiments of the present disclosure.

FIG. 7 is a flow diagram showing an illustrative method for generating a localized preview in accordance with various embodiments of the present disclosure.

FIG. 8 is a flow diagram showing an illustrative method for dynamically updating a localized preview in accordance with various embodiments of the present disclosure.

FIG. 9 is a block diagram of an example computing device in which embodiments of the present disclosure may be employed.

### DETAILED DESCRIPTION

Digital image editing commonly refers to the procedures utilized to modify or create digital images. In particular, these procedures can be utilized to generate, manipulate, enhance, or transform a digital image. Generally, a graphics editor facilitates the implementation of these procedures. For example, a graphics editor can be utilized to crop an image, adjust color of an image, combine images, reduce noise within an image, etc. One tool that is commonly utilized for digital image editing within graphics editors is a digital brush. A digital brush is utilized to apply brush strokes, to a digital image to selectively modify various regions of a digital image. In this regard, a digital brush can be utilized to apply any changes or modifications to a digital image, such as, for example, effects or styles (e.g., filters), including various textures, patterns, shading, shapes, styles, gradients, and/or the like.

Under the current state of the art, a user wishing to utilize a digital brush to selectively modify a region of a digital image makes an initial prediction as to the digital brush that might accomplish a desired modification and then applies the digital brush to the region utilizing a brush stroke. Often, the initial prediction for the digital brush does not accomplish the modification that was desired by the user, and the user must go through an iterative process to achieve the desired modification. This iterative process may include undoing, or reverting, the previous brush stroke. Typically, the user then selects a new digital brush, or settings associated therewith, and applies the new digital brush to the image in the hopes that the new brush will accomplish the desired effect. This can continue through many cycles until the user finally achieves the desired modification or gives up and accepts the modification as is, which would result in a modification that was not what was desired by the user. As such, this iterative process can be very time consuming and ultimately frustrating for the user as the user struggles to achieve the desired modification.

Embodiments of the present invention are directed at localized previewing of the effects of a brush when editing a digital image without the need to actually apply the digital brush to the digital image. Providing a localized preview enables a user to preview an effect of a digital brush as if it were applied to the image without requiring alteration of the digital image being edited. As such, a user can determine whether to apply the effects of a selected digital brush without performing various editing cycles to achieve a desired appearance. In accordance with a user selecting a digital brush and/or one or more settings (e.g., hardness, opacity, shape, size, etc.) associated with the digital brush, a localized preview can be generated for a selected portion, or region, of the digital image in which the user would like to view a localized preview. The selection of this portion of the digital image can be accomplished, for example, by placing a brush cursor (e.g., via a mouse, stylus, etc.) over a region of the digital image in which the user wishes to view a preview of the effects of the brush. A localized preview of the selected portion of the digital image can be rendered in accordance with the one or more settings of the digital brush, as described herein. As such, the user can view a preview of the effect of the digital brush without the need to actually apply the brush to the rendered image.

In embodiments, to display a localized preview that reflects the effect of a selected digital brush, a graphics editor can be configured to identify a region of a digital image being edited that the user wishes to view a localized preview of. Such identification can be accomplished, for example, by determining a location of a brush cursor with respect to the digital image. Once the region of the digital image selected by the user has been identified, a localized preview of the determined region can be generated. This can be accomplished, for example, by creating a copy of the identified region of the digital image and applying the selected digital brush to the copy to generate the localized preview, while maintaining a current state of the digital image. Once the localized preview has been generated, the localized preview can be displayed to the user, for example, by overlaying the identified region of the digital image with the localized preview. In embodiments, the localized preview can be dynamically updated based on a change to the determined region (e.g., movement of the determined region) or a change to the selected digital brush (e.g., selection of a new digital brush).

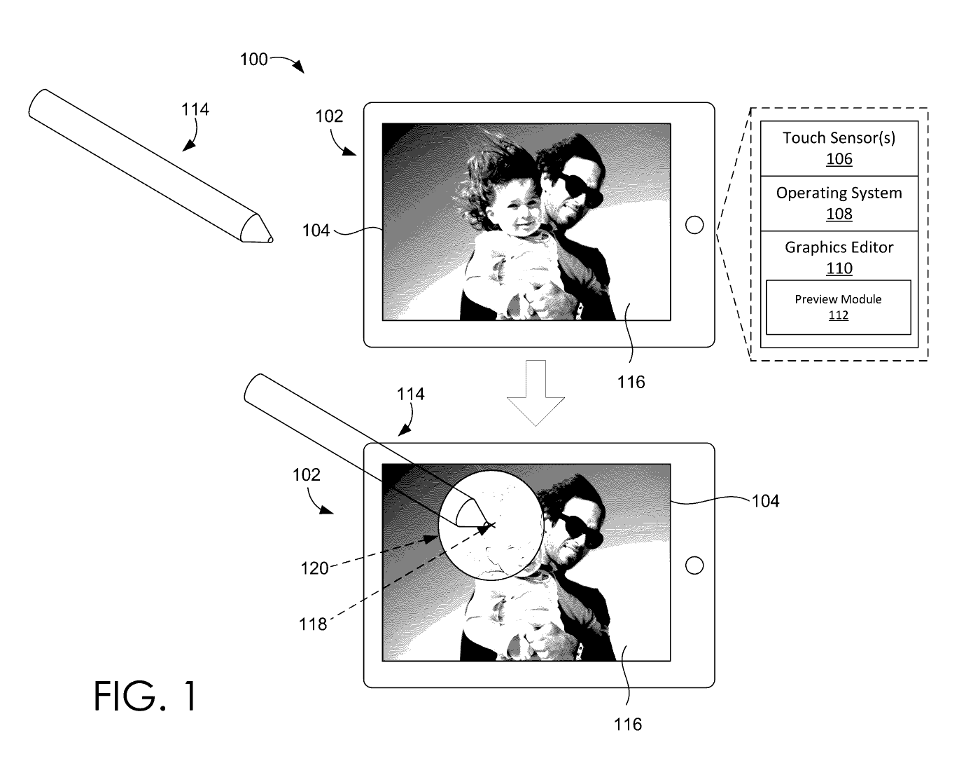

FIG. 1 depicts an illustrative computing environment 100 in accordance with various embodiments of the present invention. As depicted, computing environment 100 includes an example computing device 102 along with an example stylus 114, hereinafter respectively referred to as computing device 102 and stylus 114 for simplicity. It will be appreciated that computing device 102 and stylus 114 are merely meant to be illustrative of a possible computing device and possible stylus and that the composition of these items depicted in FIG. 1, and described below, is selected for ease of explanation and should not be treated as limiting of this disclosure.

As can be seen, computing device 102 includes components such as display screen 104, touch sensor(s) 106, operating system 108, graphics editor 110, and preview module 112. It will be appreciated that computing device 102 can include additional or fewer components without departing from the scope of this disclosure and that the depicted components are merely selected for the purpose of illustrating a possible embodiment of the present disclosure. The operating system 108 can be any conventional operating system known in the art, such as, for example, any version of Windows® (available from Microsoft Corp. of Redmond, Wash.); Android™ (available from Google Inc. of Mountain View, Calif.); iOS® (available from Apple Inc. of Cupertino, Calif.), etc. Graphics editor 110 can be any suitable graphics editor, such as, for example, ADOBE® Illustrator or ADOBE® Photoshop (both available from Adobe Systems Inc. of San Jose, Calif.).

Display screen 104 can be configured to visually present, render, display, or output information, such as, for example, drawings, sketches, images, text, figures, symbols, videos, video clips, movies, photographs, or any other content. As depicted, in some embodiments, display screen 104 is integrated with computing device 102. In other embodiments, such a display screen may be coupled with a computing device by way of a wired or wireless connection. Such a wired or wireless connection could include, for example, a video graphics array (VGA) connection, a digital visual interface (DVI) connection, a high-definition multimedia interface (HDMI) connection, wireless display (WiDi) connection, a Miracast connection, a Digital Living Network Alliance (DLNA) connection, etc.

As mentioned above, computing device 102 includes touch sensor(s) 106. The touch sensor(s) 106 may configure display screen 104 as a touch sensitive display. A touch sensitive display enables detection of location of touches or contact within a display. In this regard, a touch sensitive display refers to a display screen to which a user can provide input or interact therewith by making physical contact or near contact with the display screen. An illustrative example includes a user utilizing stylus 114 to tap, move, or use some other form of touch action, to interact with computing device 102. Other items, such as the user's finger, fingernail, etc., may be used to provide input to computing device 102 by way of touchscreen display. As such, a touch sensitive display can be used as an input component irrespective of whether a keyboard or mouse is used as an input component for interacting with displayed or rendered content, such as, for example, rendered image 116. As depicted, the touch sensor(s) 106 would enable such input to computing device 102 through display screen 104. Such input could be utilized, for example, to navigate operating system 108 or an application executing on computing device 100, such as graphics editor 110. As another example, such input could also be utilized to move a brush cursor (e.g., brush cursor 118) across display screen 104 or otherwise select a portion of an image rendered on display screen 104 to cause a localized preview of the portion to be displayed. As used herein, a brush cursor is indicative of a current location of a digital brush with respect to display screen 104 or an image rendered thereon (e.g., rendered image 116). It will be appreciated that, in other embodiments, other mechanisms such as, for example, a mouse, drawing tablet, touch pad, etc. could be utilized in place of, or in addition to, touch sensor(s) 106 to enable the above mentioned interaction with computing device 102.

The touch sensor(s) 106 may include any touch sensor capable of detecting contact, or touch, of an object with display screen 104 of computing device 102. As mentioned above, such an object could be, for example, stylus 114, a user digit (e.g., a finger), or another component that contacts display screen 104. The touch sensor(s) 106 may be any sensor technology suitable to detect an indication of touch. By way of example, and not limitation, the touch sensor(s) 106 might be resistive, surface-acoustic wave, capacitive, infrared, optical imaging, dispersive signal, acoustic pulse recognition, or any other suitable touch sensor technologies known in the art. Furthermore, as can be appreciated, any number of touch sensors may be utilized to detect contact with display screen 104.

In operation, a touch sensor detects contact of an object with at least a portion of display screen 104 of computing device 102. A touch sensor may generate a signal based on contact with at least a portion of display screen 104. In some embodiments, this signal may further be based on an amount of pressure applied to display screen 104. In one embodiment, the one or more touch sensor(s) 106 may be calibrated to generate a signal or communicate the signal upon exceeding a certain threshold. Such a threshold may be generally accepted as being representative of sufficient contact to reduce the risk of accidental engagement of the touch sensors. For example, in an instance when the touch sensor(s) 106 measures a certain threshold temperature or conductivity, the touch sensor(s) 106 may generate a signal and communicate the signal to, for example, the operating system 108 of the computing device. On the other hand, when the touch sensor(s) 106 do not measure the certain threshold temperature or conductivity, the touch sensor(s) 106 may not generate the signal or communicate the signal to the operating system 108. The touch sensor(s) 106 may be configured to generate signals based on direct human contact or contact by another object (e.g., stylus 114, etc.). As can be appreciated, the sensitivity of the touch sensor(s) 106 implemented into the computing device 102 can affect when contact with display screen 104 is registered or detected.

In one embodiment, the signal generated by the touch sensor(s) 106 may be communicated, directly or indirectly, to the operating system 108. As used in this context, the signal generated by the touch sensor(s) 106 may include raw signal data or a result of a calculation based upon raw signal data (e.g., to normalize the raw signal data). The communication of the signal to the operating system 108 may be accomplished, for example through the use of a driver application. Driver applications are known in the art and will not be discussed any further. The operating system 108 can, in some embodiments, provide the signal to the graphics editor 110 and/or preview module 112.

Although the computing device 102 of FIG. 1 is described as a having a touch sensitive display screen, as can be appreciated, computing devices without a touch sensitive display screen are contemplated as within the scope of embodiments described herein. In this regard, point(s) selected via a drawing tablet, mouse, touchpad or other input device can be detected and used in accordance herewith to initiate the display of the localized preview discussed herein.

Graphics editor 110 is generally configured to, among other things, generate, manipulate, enhance, or transform a rendering of a digital image, such as rendered image 116. To accomplish this, graphics editor 110 can be configured with a plurality of digital brushes that can be individually selected to apply brush strokes, or effects, to rendered image 116 to selectively modify various regions of rendered image 116. Each of the plurality of digital brushes can have settings associated therewith, such as, for example, settings for hardness, opacity, shape, size, etc. In embodiments, the settings for a digital brush may be adjustable by a user of graphics editor 110 to adjust the effect of the digital brush. These adjustments can be made, for example, by modifying the settings associated with the digital brush or by selecting a different digital brush altogether.

As depicted, graphics editor 110 includes preview module 112 integrated therewith. Preview module 112 could be integrated with graphics editor 110, as depicted, in any number of ways, for example, preview module 112 could be a plug-in module that can be utilized to extend the capabilities of graphics editor 110 or could be integrated as a built-in component of graphics editor 110. It will be appreciated that these configurations for integrating preview module 112 with graphics editor 110 are utilized solely for the purpose of illustration and that other configurations are within the scope of the present disclosure. In addition, in other embodiments, preview module 112 could be a stand-alone application that interfaces (e.g., via application programming interfaces (APIs)) with graphics editor 110.

In embodiments, preview module 112 can be configured to cause a localized preview of a brush stroke, or effect, of a selected digital brush, to be displayed to the user without the need for the user to actually apply the brush stroke, or effect, to rendered image 116. To accomplish this, preview module 112 can be configured to determine a region (e.g., region 120) of rendered image 116 for which the user wishes to view a localized preview. This determination can be made, for example, based on input received from a user of the computing device. As depicted, such input could be placement, utilizing stylus 114 or any other suitable input device, of brush cursor 118 over a region of rendered image 116 that the user wishes to view a localized preview of. In such an example, the region could be further determined based on a size and/or shape of the selected digital brush. As such, the determined region could be centered at the location of brush cursor 118 and could extend outwardly from the location of brush cursor 118 to reflect the size and/or shape of the selected digital brush, as reflected by region 120. A determined region that reflects a location of a brush cursor in conjunction with the size and/or shape of the selected digital is referred to herein as a brush cursor area.

In other embodiments, the input provided by the user could be provided by the user drawing a perimeter around the region, or otherwise selecting the region, of the rendered image for which the user wishes to view a localized preview. This perimeter could be drawn utilizing a selection tool, such as, for example, a circular selection tool, a rectangular selection tool, a freeform selection tool (e.g., the lasso tool provided with ADOBE® Photoshop), or any other suitable selection tool. In such embodiments, the determined region would coincide with that portion of the rendered image that lies within the perimeter drawn by the user.

Once the region that the user wishes to see a localized preview of has been determined, preview module 112 can be configured to generate a localized preview of the determined region, such as that depicted within region 120. In some embodiments, this can be accomplished by creating a copy of the determined region of rendered image 116 in memory of computing device 102. Preview module can then apply the selected digital brush to the copy of the region to generate a preview region that would be utilized as the localized preview. In other embodiments, preview module 112 creates a copy of the entire rendered image 116 in memory and applies the selected digital brush to the copy of the entire rendered image to generate a preview image. In such an embodiment, the preview module 112 may generate the localized preview by determining a preview region of the preview image that corresponds with the determined region (e.g., region 120) of the rendered image 116 and utilize this preview region as the localized preview. In still other embodiments, a preview region larger than the determined region, but smaller than the entire rendered image, could be utilized to generate the localized preview.

Upon generating a localized preview, the preview module 112 can cause the localized preview to be rendered on display screen 104 of computing device 102. As discussed above, the localized preview reflects the application of a currently selected digital brush to the determined region. In the example depicted in FIG. 1, the effect of the selected digital brush is the find edges filter. In embodiments, preview module 112 causes the localized preview to be rendered within the determined region, as depicted within region 120. By way of example, and without limitation, the determined region can be overlaid with the localized preview such that the user is able to see the effect of the selected digital brush as if it were applied to the determined region of the rendered image 116. As such, the size of rendered image 116 could be maintained regardless of whether the user is viewing the localized preview or not.

As mentioned previously, the selected digital brush may be an initial guess as to the digital brush that might accomplish a desired modification. As such, once the user is able to view the localized preview, the user may then decide to either adjust settings via the graphics editor associated with the selected digital brush or select a new digital brush that may better accomplish what the user desires. In embodiments, preview module 112, can also be configured to detect a change to the digital brush. Such a change could be caused through adjustments to the settings (e.g., hardness, opacity, shape, size, style, effect, etc.) associated with the selected digital brush or the selection of a new digital brush. In response to detecting the change to the digital brush, preview module 112 can be configured to dynamically update the localized preview to reflect the change. Such an update can occur in a similar manner to that described above with respect to generating the localized preview.

In addition, the user may wish to view a localized preview of other areas of rendered image 116 and, as a result, may select a different region of the rendered image. This may be accomplished, for example, by moving the location of the brush cursor or by moving the location of the perimeter. As such, preview module 112, can detect a change to the location of the selected region and dynamically update the localized preview to reflect the change in location.

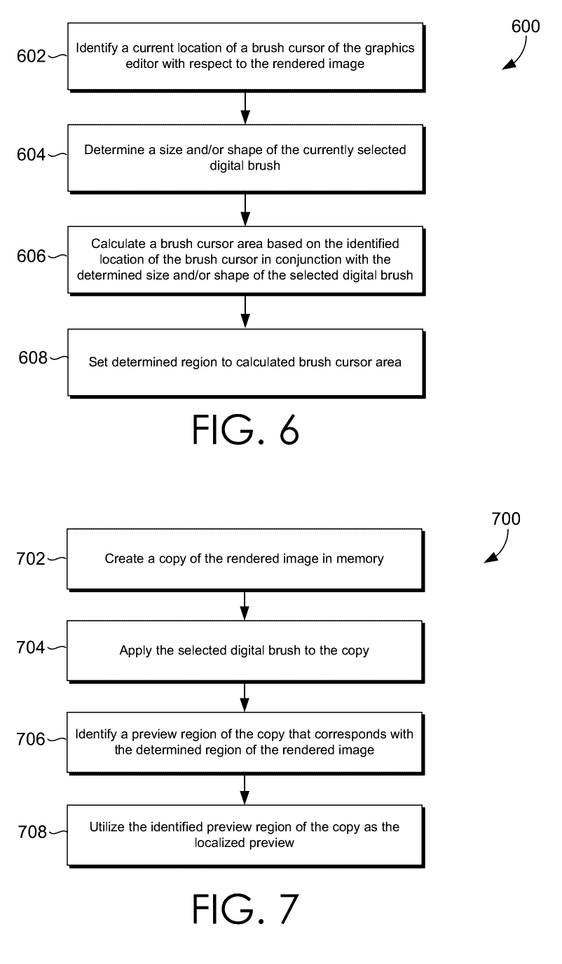

The computing device 102 can be any device associated with a display screen 104, such as the computing device 600 of FIG. 6. In some embodiments, the computing device 102 is a portable or mobile device, such as a tablet, mobile phone, a personal digital assistant (PDA), a laptop, or any other portable device associated with a display screen.

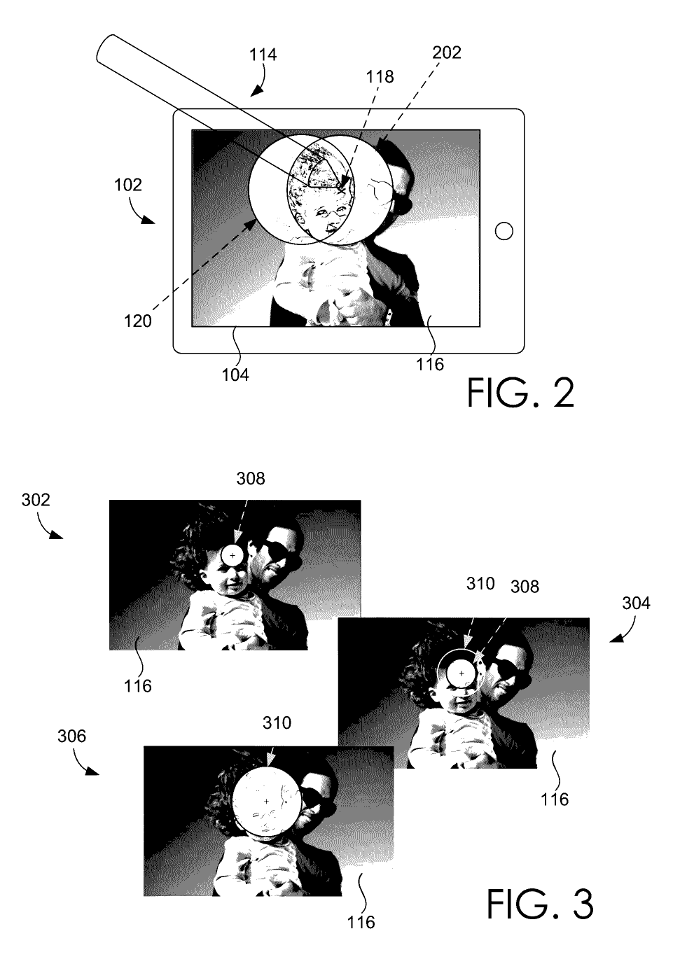

FIG. 2 depicts an exemplary application of a selected digital brush and an update of a localized preview, in accordance with various embodiments of the present disclosure. FIG. 2 includes computing device 102 of FIG. 1, and, as a result, many of the reference numbers depicted within FIG. 2 correspond with reference numbers discussed above in reference to FIG. 1. As can be seen in FIG. 2, the selected digital brush has now been applied to region 120. The application of the selected digital brush to region 120 can occur through any conventional mechanism, such as, for example, activation of a button or control integrated with stylus 114. Now assume brush cursor 118 is moved from the location depicted in FIG. 1 to a new location which corresponds with region 202. As such, the localized preview is updated to reflect this new location, and the updated localized preview is rendered to coincide with region 202. The updating of the localized preview can occur in a similar manner to that described above with respect to generating the localized preview. As can be appreciated, because the selected digital brush has now been applied to region 120, which caused a change to rendered image 116, the area of region 202 that overlaps with region 120 reflects application of the selected digital brush in light of this change to rendered image 116. As such, the area of overlap between region 202 and region 120 reflects a double application of the find edges filter. It will be appreciated that, as region 202 is moved further away from region 120, that the regions will no longer overlap.

FIG. 3 depicts updating of a localized preview, in accordance with various embodiments of the present disclosure. As can be seen, FIG. 3 again includes rendered image 116. At 302, the region of rendered image 116 that the user wishes to view a localized preview of is represented by region 308. As discussed above in reference to FIG. 1, region 308 can be selected utilizing a brush cursor that is indicative of a location of a digital brush with respect to rendered image 116. In addition, the size of the region might be determined based on a size of the selected digital brush. At 304, the size of the selected digital brush is being enlarged as depicted by region 310. Changing the size of the selected digital brush can be accomplished, for example, by selecting a different size for the brush within a graphics editor (e.g., graphics editor 110 of FIG. 1). At 306, as can be seen within region 310, the localized preview has been automatically updated to reflect the change to the size of the selected digital brush. This update can be accomplished as described herein.

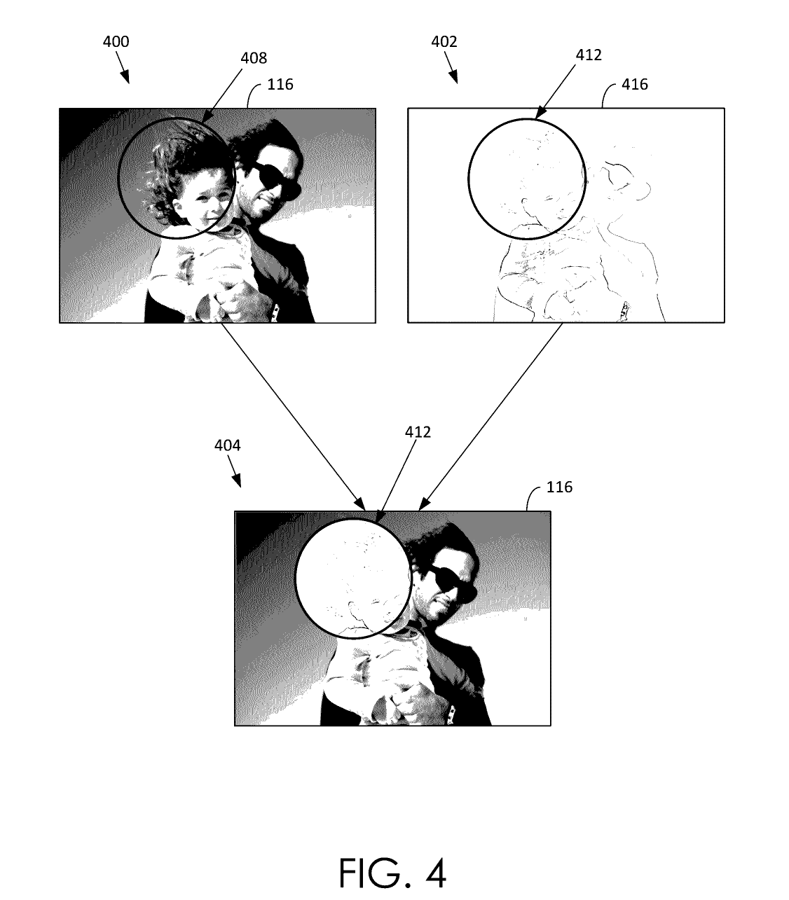

FIG. 4 depicts generation and display of a localized preview, in accordance with various embodiments of the present disclosure. As depicted at 400, the region of rendered image 116 that the user wishes to see a localized preview of has been determined to be region 408 of rendered image 116. Such a determination can be made, for example, in the same manner as that described above in reference to FIG. 1 for determining region 120. In the depicted embodiment, at 402 a copy of the entire rendered image 116 is created and a selected digital brush is applied to the copy to generate a preview image 416. In such an embodiment, the localized preview is generated by determining a preview region 412 of the preview image that corresponds with region 408 of the rendered image 116. Preview region 412 can then be rendered (e.g., as an overlay) within the region 408 without any changes being applied to the underlying region 408, as depicted at 404. As used herein, an overlay refers to a layer that has been placed over a region (e.g., region 408) of a rendered image (e.g., rendered image 116) without causing any actually changes to the rendered image. An overlay could also be referred to in the art as a graphics sprite. Graphics sprites are known in the art and will not be discussed any further herein. As such, the state of rendered image 116 is the same prior to preview region 412 being overlaid as it is after the preview region 412 has been overlaid. As used herein, a state of an image can refer to the state of the rendered image in memory of a computing device.

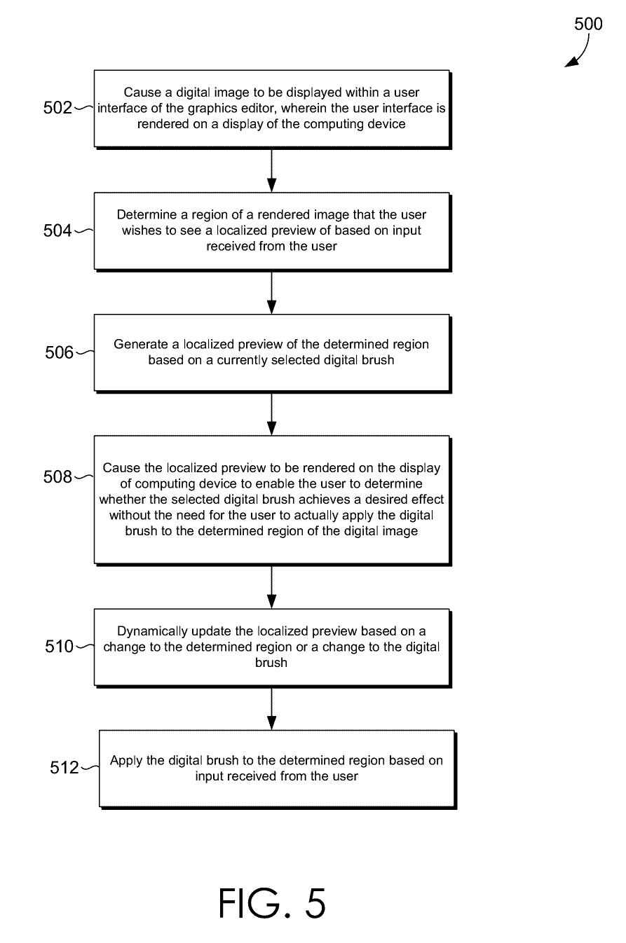

FIG. 5 depicts a process flow 500 showing a method for facilitating a localized preview on a computing device in accordance with various embodiments of the present disclosure. Process flow 500 could be carried out by a graphics editor, such as, for example, graphics editor 110 with preview module 112 of FIG. 1. Initially, the process flow begins at block 502 where the graphics editor causes a digital image to be displayed within a user interface of the graphics editor to enable editing of the digital image within the graphics editor. This procedure could be the result of the user opening the digital image for editing. Such a procedure is well-known in the art and will not be discussed any further herein.

At block 504, a region of the rendered image that the user wishes to view a localized preview of is determined. This determination can be made, for example, based on input received from a user of the computing device. Such input could, in some embodiments, be placement of a brush cursor over a region of the rendered image for which the user wishes to view a localized preview. In such an example, the region could be further determined based on a size and/or shape of the selected digital brush. As such, the determined region could be centered at the location of brush cursor and could extend outwardly from the location of the brush cursor to reflect the size and/or shape of the selected digital brush. In other embodiments, the input provided by the user could be provided by the user drawing a perimeter around the region, or otherwise selecting the region, of the rendered image for which the user wishes to view a localized preview. This perimeter could be drawn utilizing a selection tool, such as, for example, a circular selection tool, a rectangular selection tool, a freeform selection tool (e.g., the lasso tool provided with ADOBE® Photoshop), or any other suitable selection tool. In such embodiments, the determined region would coincide with that portion of the rendered image that lies within the perimeter drawn by the user.

At block 506, a localized preview is generated based on the region determined at block 504. In some embodiments, this can be accomplished by creating a copy of the determined region in memory of the computing device. Once such a copy is created, then the selected digital brush can be applied to the copy to generate a preview region that would be utilized as the localized preview. In other embodiments, a copy of the entire rendered image could be created in memory. The selected digital brush may then be applied to the copy of the entire rendered image to generate a preview image. In such an embodiment, the localized preview could be generated by determining a preview region of the preview image that corresponds with the determined region of the rendered image. This preview region could then be utilized as the localized preview. In still other embodiments, a preview region larger than the determined region, but smaller than the entire rendered image, could be utilized to generate the localized preview.

At block 508, the graphics editor causes the localized preview generated at block 506 to be rendered on a display of the computing device. In embodiments, the localized preview can be rendered within the determined region, such that the determined region appears to be replaced by the localized preview without the need for the user to actually apply the digital brush to the digital image and without any change to the state of the underlying digital image. This could be accomplished, for example, by overlaying the determined region with the localized preview so that the user is able to see the effect of the selected digital brush as if it were applied to the determined region without any changes actually occurring to the rendered image. Because the localized preview is displayed within the determined region, the size of the rendered image could be the same when viewing the localized preview as it is when a localized preview is not being viewed.

At block 510, the graphics editor can dynamically update the localized preview based on a change to the determined region. Such a change could be a change to the location, size, and/or shape of the determined region. This change could be reflected through movement of the brush cursor by the user, movement of the previously discussed perimeter by the user, redrawing of the perimeter by the user, resizing of the brush by the user, etc. As such, the graphics editor can cause the localized preview to be updated automatically to reflect a new location and/or shape of the determined region. In addition, at block 510, the graphics editor can also dynamically update the localized preview based on a change to the digital brush. Such a change could be reflected through adjustments to one or more settings (e.g., hardness, opacity, shape, size, style, effect, etc.) associated with the selected digital brush or the selection of a new digital brush.

At block 512, the user may apply the digital brush to the determined region. This can be accomplished, for example, via a mouse click by the user, activation/deactivation of a button on a stylus, or any other suitable input mechanism that is utilized for applying a change to a digtial image within a graphics editor. The application of this change can occur once the user is satisfied with the determined region and the effects of the selected digital brush on the determined region. It will be appreciated that the above described process flow can be carried out any number of times by the user depending on the number of edits or changes the user wishes to make with respect to the digital image.

FIG. 6 depicts a process flow 600 showing an illustrative method for determining a region of a rendered image that the user wishes to see a localized preview of, in accordance with various embodiments of the present disclosure. Process flow 600 could be carried out by a graphics editor, such as, for example, graphics editor 110 with preview module 112 of FIG. 1. Initially, the process flow begins at block 602 where a current location of a brush cursor with respect to a rendered image is identified. The process for determining a current location of a cursor is well known in the art and will not be discussed further herein.

At block 604, a size and/or shape of a currently selected digital brush is determined. This can be determined through settings that are associated with the selected digital brush. At block 606, the location of the brush cursor identified at block 602 and the size and/or shape of the brush cursor determined at block 604 can be utilized to calculate a brush cursor area that reflects an area where the currently selected digital brush would be applied, if the user selected to actually apply the digital brush at the current location of the brush cursor. At block 608, the calculated brush cursor area is set to be the determined region. As such, the determined region could be centered at the current location of brush cursor and could extend outwardly from the location of the brush cursor to reflect the size and/or shape of the selected digital brush. As mentioned previously, in other embodiments, the determined region could be selected, for example, by the user drawing a perimeter around a desired region, or otherwise selecting a region, of the rendered image for which the user wishes to view a localized preview. In such embodiments, the determined region would coincide with that portion of the rendered image that lies within the perimeter drawn by the user.

FIG. 7 depicts a process flow 700 showing an illustrative method for generating a localized preview of a determined region of an image rendered in a graphics editor, in accordance with various embodiments of the present disclosure. Process flow 700 could be carried out by a graphics editor, such as, for example, graphics editor 110 with preview module 112 of FIG. 1. Process flow 700 can begin at block 702 where a copy of the rendered image is created (e.g., in memory of the computing device). At block 704, the selected digital brush is applied to the copy of the rendered image created at block 702. At block 706, a preview region of the copy created at block 702 and modified at block 704 is identified such that the preview region corresponds with a region of the rendered image that was determined, for example, as discussed extensively in reference to FIGS. 1-6, above. At block 708, the identified preview region can be utilized as the localized preview.

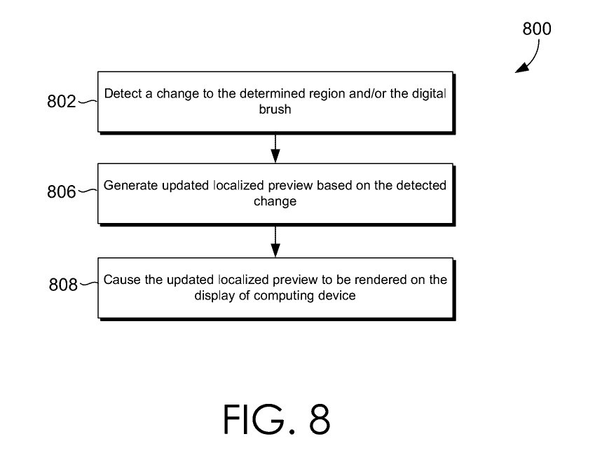

FIG. 8 depicts a flow diagram showing an illustrative method for dynamically updating a localized preview in accordance with various embodiments of the present disclosure. Process flow 800 could be carried out by a graphics editor, such as, for example, graphics editor 110 with preview module 112 of FIG. 1. Process flow 800 can begin at block 802 where a change to the determined region and/or a change to the digital brush has occurred. A change to the determined region could include a change to a location, size, and/or shape of the determined region. A change to the digital brush could include a change to any setting associated with the selected digital brush or selection of a new digital brush. Once a change has been detected to the determined region and/or the digital brush, at block 806 an updated localized preview can be generated based on the detected change(s). The process to generate the updated localized preview can follow a same or similar process to that described above in reference to generating the localized preview. At block 808, the localized preview is rendered on the display of the computing device to replace the previous localized preview. It will be appreciated that this process flow can be performed almost seamlessly via background processing so that the user can view changes to the determined region and/or the selected digital brush in real time, or substantially real time (e.g., accounting for processing latency).

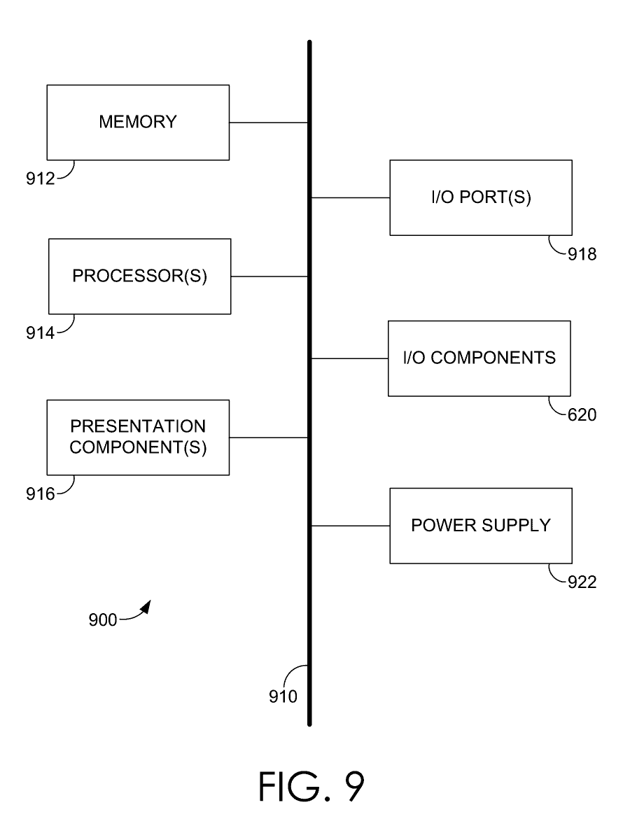

Having described embodiments of the present invention, an example operating environment in which embodiments of the present invention may be implemented is described below in order to provide a general context for various aspects of the present invention. Referring to FIG. 9, an illustrative operating environment for implementing embodiments of the present invention is shown and designated generally as computing device 900. Computing device 900 is but one example of a suitable computing environment and is not intended to suggest any limitation as to the scope of use or functionality of the invention. Neither should the computing device 900 be interpreted as having any dependency or requirement relating to any one or combination of components illustrated.

Embodiments of the invention may be described in the general context of computer code or machine-useable instructions, including computer-executable instructions such as program modules, being executed by a computer or other machine, such as a smartphone or other handheld device. Generally, program modules including routines, programs, objects, components, data structures, etc., refer to code that perform particular tasks or implement particular abstract data types. Embodiments of the invention may be practiced in a variety of system configurations, including hand-held devices, consumer electronics, general-purpose computers, more specialized computing devices, etc. Embodiments of the invention may also be practiced in distributed computing environments where tasks are performed by remote-processing devices that are linked through a communications network.

With reference to FIG. 9, computing device 900 includes a bus 910 that directly or indirectly couples the following devices: memory 912, one or more processors 914, one or more presentation components 916, input/output (I/O) ports 918, I/O components 920, and an illustrative power supply 922. Bus 910 represents what may be one or more busses (such as an address bus, data bus, or combination thereof). Although depicted in FIG. 9, for the sake of clarity, as delineated boxes that depict groups of devices without overlap between these groups of devices, in reality this delineation is not so clear cut and a device may well fall within multiple ones of these depicted boxes. For example, one may consider a display to be one of the one or more presentation components 916 while also being one of the I/O components 920. As another example, processors have memory integrated therewith in the form of cache; however, there is no depicted overlap between the one or more processors 914 and the memory 912. A person having of skill in the art will readily recognize that such is the nature of the art, and it is reiterated that the diagram of FIG. 9 merely depicts an illustrative computing device that can be used in connection with one or more embodiments of the present invention. It should also be noticed that distinction is not made between such categories as “workstation,” “server,” “laptop,” “hand-held device,” etc., as all such devices are contemplated to be within the scope of computing device 900 of FIG. 9 and any other reference to “computing device,” unless the context clearly indicates otherwise.

Computing device 900 typically includes a variety of computer-readable media. Computer-readable media can be any available media that can be accessed by computing device 900 and includes both volatile and nonvolatile media, and removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 900. Computer storage media does not comprise or include signals per se, such as, for example, carrier waves. Communication media, on the other hand, typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 912 includes computer-storage media in the form of volatile and/or nonvolatile memory. The memory may be removable, non-removable, or a combination thereof. Typical hardware devices may include, for example, solid-state memory, hard drives, optical-disc drives, etc. Executable instructions for carrying out the process described above or to implement one or more modules described above would be contained within memory 912. Computing device 900 includes one or more processors 914 that read data from various entities such as memory 912 or I/O components 920. Presentation component(s) 916 present data indications to a user or other device. Illustrative presentation components include a display device, speaker, printing component, vibrating component, etc.

I/O ports 918 allow computing device 900 to be logically coupled to other devices including I/O components 920, some of which may be built in. Illustrative components include a stylus, such as that discussed elsewhere herein, a drawing tablet, such as that discussed elsewhere herein, a microphone, joystick, game pad, satellite dish, scanner, printer, wireless device, etc. The I/O components 920 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described elsewhere herein) associated with a display of the computing device 900. The computing device 900 may be equipped with depth cameras, such as stereoscopic camera systems, infrared camera systems, RGB camera systems, touchscreen technology, and combinations of these, for gesture detection and recognition. Additionally, the computing device 900 may be equipped with accelerometers or gyroscopes that enable detection of motion. The output of the accelerometers or gyroscopes may be provided to one or more software modules or applications that may cause the display of the computing device 900 to render immersive augmented reality or virtual reality.

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in a limiting sense, and the scope of embodiments is defined by the appended claims and their equivalents.

Various aspects of the illustrative embodiments have been described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features have been omitted or simplified in order not to obscure the illustrative embodiments.

Various operations have been described as multiple discrete operations, in turn, in a manner that is most helpful in understanding the illustrative embodiments; however, the order of description should not be construed as to imply that these operations are necessarily order dependent. In particular, these operations need not be performed in the order of presentation. Further, descriptions of operations as separate operations should not be construed as requiring that the operations be necessarily performed independently and/or by separate entities. Descriptions of entities and/or modules as separate modules should likewise not be construed as requiring that the modules be separate and/or perform separate operations. In various embodiments, illustrated and/or described operations, entities, data, and/or modules may be merged, broken into further sub-parts, and/or omitted.

The phrase “in one embodiment” or “in an embodiment” is used repeatedly. The phrase generally does not refer to the same embodiment; however, it may. The terms “comprising,” “having,” and “including” are synonymous, unless the context dictates otherwise. The phrase “A/B” means “A or B.” The phrase “A and/or B” means “(A), (B), or (A and B).” The phrase “at least one of A, B and C” means “(A), (B), (C), (A and B), (A and C), (B and C) or (A, B and C).”

What is claimed is:

1. One or more computer-readable storage media having executable instructions stored thereon, which, in response to execution by a processor of a computing device, provide the computing device with a graphics editor to:
cause a digital image to be displayed within a user interface, wherein the user interface is rendered on a display of the computing device;
determine, based on input received from a user of the computing device, a region of the digital image for which the user wishes to view a localized preview; and
while maintaining a state of the digital image, cause a localized preview to be rendered over the determined region of the digital image, wherein the localized preview reflects application of a currently selected digital brush to the determined region and enables the user to determine whether the selected digital brush achieves a desired effect without altering the state of the digital image.

2. The one or more computer-readable media of claim 1, wherein the input received from the user is a selection of the region by the user.

3. The one or more computer-readable storage media of claim 1, wherein to determine the region of the image comprises determining a brush cursor location that is indicative of a current location of the digital brush with respect to the rendered image.

4. The one or more computer-readable storage media of claim 3, wherein to determine the region is based on a combination of the brush cursor location and a size of the digital brush.

5. The one or more computer-readable storage media of claim 5, wherein to cause the localized preview to be rendered within the determined region is to cause the localized preview to overlay the determined region of the rendered image.

6. The one or more computer-readable storage media of claim 1, wherein the digital brush is includes one or more settings that define an effect that is to be applied by the digital brush.

7. The one or more computer-readable storage media of claim 6, wherein the graphics editor is further configured to:
detect a change to at least one of the one or more settings of the digital brush; and
cause the localized preview be updated to reflect the at least one changed setting.

8. The one or more computer-readable storage media of claim 1, wherein the graphics editor is further configured to: generate the localized preview by creating a copy of at least the determined region and applying the digital brush to the copy.

9. The one or more computer-readable storage media of claim 1, wherein the graphics editor is further configured to:
detect, based on input received from the user, a change to a size or location of the region; and
cause the localized preview be updated to reflect the change.

10. A computer-implemented method for previewing an effect of a digital brush, the method comprising:
causing, by a graphics editor, an image to be rendered within a user interface of the graphics editor to enable a user of the computing device to edit the digital image utilizing the digital brush;
determining a brush cursor location that is indicative of a current location of the digital brush with respect to the rendered image; and
causing a localized preview to be rendered on the display of the computing device while maintaining a state of the rendered image, wherein the localized preview reflects application of the digital brush to an area of the rendered image that corresponds with the brush cursor location and enables the user to determine whether the digital brush achieves a desired effect without the need to actually apply the digital brush to the rendered image.

11. The computer-implemented method of claim 11, wherein causing a localized preview to be rendered on the display comprises causing the localized preview to be rendered at the determined brush cursor location.

12. The computer-implemented method of claim 12, wherein causing the localized preview to be rendered at the determined brush cursor location comprises causing the localized preview to overlay a portion of the rendered image that is identified by the determined brush cursor location.

13. The computer-implemented method of claim 11, wherein causing a localized preview to be rendered on the display comprises causing the localized preview to be rendered in accordance with the size of the digital brush.

14. The computer-implemented method of claim 11, further comprising:
creating a copy of the rendered image in a memory of the computing device; and
applying the digital brush to the copy of the rendered image, and wherein to cause the localized preview to be rendered on the display is to cause a portion of the copy of the rendered image that corresponds with the area of the rendered image identified by the determined brush cursor location to be rendered on the display.

15. The computer-implemented method of claim 11, further comprising:
dynamically updating the localized preview based on movement of the digital brush.

16. The computer-implemented method of claim 11, wherein the digital brush is associated with one or more settings that define an effect to be applied by the digital brush, the method further comprising:
detecting a change to at least one of the one or more settings associated with the brush; and
automatically updating the localized preview to reflect the at least one changed setting, wherein the one or more settings include one or more of a size setting, a hardness setting, an opacity setting, and a shape setting.

17. A computing device comprising:
one or more processors; and
memory, coupled with the one or more processors, having executable instructions stored thereon, which, in response to execution by the one or more processors, provide the computing device with a graphics editor to:
cause an image to be rendered on a display that is coupled with the computing device;
receive input from a user of the computing device identifying a region of the rendered image that the user wishes to view a localized preview of;
generate the localized preview, wherein the localized preview reflects application of a currently selected digital brush to the identified region; and
cause the localized preview to overlay the identified region on the display of the computing device.

18. The computing device of claim 18, wherein to generate the localized preview the graphics editor is further to:
create a copy of at least a portion of the rendered image in the memory; and
apply the digital brush to the copy to create a preview region, and wherein to cause the localized preview to overlay the selected region is to cause a portion of the preview region that corresponds with the selected region to overlay the selected region on the display.

19. The computing device of claim 18, wherein the graphics editor is further to:
detect selection of a different digital brush by the user; and
cause the localized preview be updated to reflect the different digital brush.

20. The computing device of claim 18, wherein the graphics editor is further to:
dynamically update the localized preview based on movement of the digital brush.
